(19) United States
(12) Patent Application Publication
(10) Pub. No.: US 2010/0255909 A1
(43) Pub. Date: Oct. 7, 2010

(54) Systems and Methods for Managing Virtual Objectives in a Video Game

(76) Inventor: Brendan McNamara, Sydney (AU)

Correspondence Address: BRACEWELL & GIULIANI LLP, P.O. BOX 61389, HOUSTON, TX, 77208-1389, US

(21) Appl. No.: 12/727,420

(22) Filed: Mar. 19, 2010

(30) Foreign Application Priority Data
Mar. 20, 2009 (AU) 2009901224

(51) Int. Cl. A63F 13/00; A63F 13/12

(52) U.S. Cl. 463/31; 463/42

(57) ABSTRACT

The present invention relates to systems and methods for managing virtual objectives in a video game. Embodiments of the invention have been particularly developed for providing a “treasure hunt” style functionality to a video game, whereby distributed players compete to locate a uniquely discoverable object. While some embodiments will be described herein with particular reference to that application, it will be appreciated that the invention is not limited to such a field of use, and is applicable in broader contexts.

### CROSS-REFERENCE TO RELATED APPLICATIONS

This application claims priority to Australian Application No. 2009901224, filed Mar. 20, 2009.

### FIELD OF THE INVENTION

The present invention relates to systems and methods for managing virtual objectives in a video game. Embodiments of the invention have been particularly developed to provide a framework for a “treasure hunt” style functionality to a video game, whereby distributed players compete to locate a uniquely discoverable object. While some embodiments will be described herein with particular reference to that application, it will be appreciated that the invention is not limited to such a field of use, and is applicable in broader contexts.

### BACKGROUND

Any discussion of the background art throughout the specification should in no way be considered as an admission that such art is widely known or forms part of common general knowledge in the field.

Traditionally, there are two main approaches for playing a video game. Firstly, there are offline modes, in which a player's interaction is limited by data available to a local machine. For example, the player interacts with and/or competes against AI players, or other local players (for example in a split-screen multiplayer arrangement). Secondly, at least for some games, there are online modes. In such modes, a player is able interact and/or compete with other human players who are physically located remote locations, for example via an Internet connection. Such online modes are in some cases facilitated by a central game server, or in other cases use one of the player's local machines to host a networked game.

Online game modes continue to increase in popularity, and significant commercial value can be derived from the implementation of new and unique functionalities.

### SUMMARY OF THE INVENTION

It is an object of the present invention to overcome or ameliorate at least one of the disadvantages of the prior art, or to provide a useful alternative.

One embodiment provides a method for managing virtual objects in a video game, the method including:
at a game server, defining data indicative of a virtual object, the data including an object identifier;
at the game server, providing to a plurality of client machines, data indicative of the virtual object, and data indicative of an instruction to implement the object in a virtual environment;
at a client machine, receiving the data indicative of the virtual object, and data indicative of an instruction to implement the object in a virtual environment;
at the client machine, implementing the object in the virtual environment at an object location, such that the virtual object is able to be discovered by a player when the object location and virtual object are rendered on-screen;
at the client machine, upon discovery of the virtual object by the player, providing to the game server data indicative of that discovery, including data indicative of the object identifier and data indicative of the player; and
at the game server, responsive to receipt of the data indicative of the discovery, taking action such that the virtual object is not subsequently able to be uniquely discovered by a player.

One embodiment provides a method, at a game server, for managing virtual objects in a video game, the method including:
defining data indicative of a virtual object, the data including an object identifier;
providing to a plurality of client machines data indicative of the virtual object, and data indicative of an instruction to implement the object in a virtual environment, wherein the client machines each implement the object in the virtual environment at an object location, such that the virtual object is able to be discovered by a player when the object location and virtual object are rendered on-screen and, upon discovery of the virtual object by the player, provide to the game server data indicative of that discovery, including data indicative of the object identifier and data indicative of the player; and
responsive to receipt of the data indicative of the discovery, taking action such that the virtual object is not subsequently able to be uniquely discovered by a player.

One embodiment provides a method, at a client machine, for managing virtual objects in a video game, the method including:
receiving from a game server data indicative of a virtual object, the data including an object identifier, and data indicative of an instruction to implement the object in a virtual environment, wherein the data indicative of the virtual object, and data indicative of an instruction to implement the object in a virtual environment, are provided by the game server to a plurality of client machines;
implementing the object in the virtual environment at an object location, such that the virtual object is able to be discovered by a player when the object location and virtual object are rendered on-screen;
discovery of the virtual object by the player, providing to the game server data indicative of that discovery, including data indicative of the object identifier and data indicative of the player, such that, responsive to receipt of the data indicative of the discovery, the game server responds by taking action such that the virtual object is not subsequently able to be uniquely discovered by a player.

One embodiment provides a method for managing virtual objectives in a video game, the method including:
at a game server, defining data indicative of a virtual objective, the data including an objective identifier;
at the game server, providing to a plurality of client machines, data indicative of the virtual objective, and data indicative of an instruction to implement the objective in a virtual environment;
at a client machine, receiving the data indicative of the virtual objective, and data indicative of an instruction to implement the objective in a virtual environment;
at the client machine, implementing the objective in the context of the virtual environment, such that the virtual objective is able to be completed by a player;
at the client machine, upon completion of the virtual objective by the player, providing to the game server data indicative of that completion, including data indicative of the objective identifier and data indicative of the player; and
at the game server, responsive to receipt of the data indicative of the completion, taking action such that the virtual objective is not subsequently able to be uniquely completed by a player.

One embodiment provides a method, at a game server, for managing virtual objectives in a video game, the method including:
defining data indicative of a virtual objective, the data including an objective identifier;
providing to a plurality of client machines data indicative of the virtual objective, and data indicative of an instruction to implement the objective in a virtual environment, wherein the client machines each implement the objective in the virtual environment, such that the virtual objective is able to be completed by a player and, upon completion of the virtual objective by the player, provide to the game server data indicative of that completion, including data indicative of the objective identifier and data indicative of the player; and
responsive to receipt of the data indicative of the completion, taking action such that the virtual objective is not subsequently able to be uniquely completed by a player.

One embodiment provides a method, at a client machine, for managing virtual objectives in a video game, the method including:
receiving from a game server data indicative of a virtual objective, the data including an objective identifier, and data indicative of an instruction to implement the objective in a virtual environment, wherein the data indicative of the virtual objective, and data indicative of an instruction to implement the objective in a virtual environment, are provided by the game server to a plurality of client machines;
implementing the objective in the context of the virtual environment, such that the virtual objective is able to be completed by a player;
completion of the virtual objective by the player, providing to the game server data indicative of that completion, including data indicative of the objective identifier and data indicative of the player, such that, responsive to receipt of the data indicative of the completion, the game server responds by taking action such that the virtual objective is not subsequently able to be uniquely completed by a player.

One embodiment provides a computer program product for performing a method as described herein.

One embodiment provides a non-transitive computer readable carrier medium carrying code that, when executed by one or more processors of a computer system, causes the computer system to perform a method as described herein.

One embodiment provides a computer system configured to perform a method as described herein. For example, method steps are performed based on the execution of software instructions by one or more microprocessors.

One embodiment provides a method for modifying a video game, the method including providing a software component that interacts with software instructions representative of the video game for allowing the video game to interoperate with a method as described herein, wherein the virtual environment is provided by the software instructions representative of the video game.

Reference throughout this specification to “one embodiment”, “some embodiments” or “an embodiment” means that a particular feature, structure or characteristic described in connection with the embodiment is included in at least one embodiment of the present invention. Thus, appearances of the phrases “in one embodiment”, “in some embodiments” or “in an embodiment” in various places throughout this specification are not necessarily all referring to the same embodiment, but may. Furthermore, the particular features, structures or characteristics may be combined in any suitable manner, as would be apparent to one of ordinary skill in the art from this disclosure, in one or more embodiments.

As used herein, unless otherwise specified the use of the ordinal adjectives “first”, “second”, “third”, etc., to describe a common object, merely indicate that different instances of like objects are being referred to, and are not intended to imply that the objects so described must be in a given sequence, either temporally, spatially, in ranking, or in any other manner.

In the claims below and the description herein, any one of the terms comprising, comprised of or which comprises is an open term that means including at least the elements/features that follow, but not excluding others. Thus, the term comprising, when used in the claims, should not be interpreted as being limitative to the means or elements or steps listed thereafter. For example, the scope of the expression a device comprising A and B should not be limited to devices consisting only of elements A and B. Any one of the terms including or which includes or that includes as used herein is also an open term that also means including at least the elements/features that follow the term, but not excluding others. Thus, including is synonymous with and means comprising.

### BRIEF DESCRIPTION OF THE DRAWINGS

Embodiments of the invention will now be described, by way of example only, with reference to the accompanying drawings in which:

FIG. 1 illustrates a system according to one embodiment.

FIG. 2 illustrates a client method according to one embodiment and a server method according to one embodiment.

### DETAILED DESCRIPTION

The present invention relates, to systems and methods for managing virtual objectives in a video game. Embodiments of the invention have been particularly developed for providing a “treasure hunt” style functionality to a video game, whereby distributed players compete to locate a uniquely discoverable object. While some embodiments will be described herein with particular reference to that application, it will be appreciated that the invention is not limited to such a field of use, and is applicable in broader contexts.

The nature of a virtual objective varies between embodiments, and the present description is particularly focused on an objective requiring a player to discover a specified virtual object. However, various other objectives are contemplated, including navigating to a predefined virtual location, completing a virtual puzzle or task, attending a virtual event, and so on.

### System Level Overview

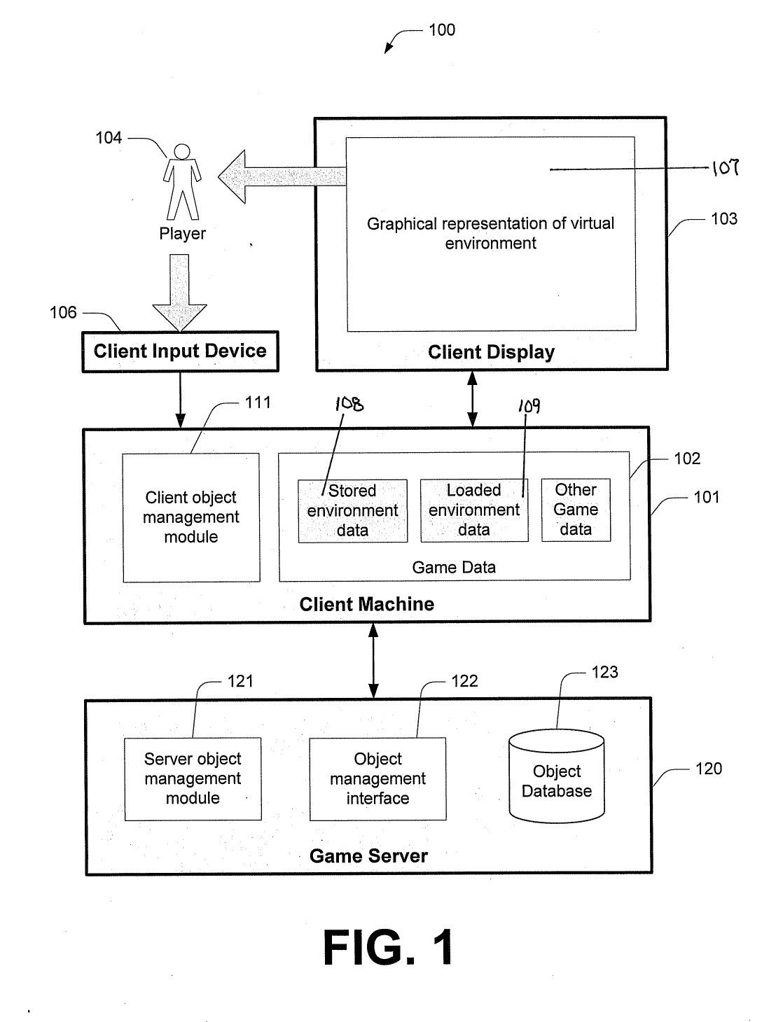

FIG. 1 illustrates a system 100 according to one embodiment. In an overview, a video game executes at a client machine 101. This client machine may take the form of a gaming console (portable or non-portable), personal computer, cell phone, PDA, or other computational platform. In this regard, the client machine includes one or more memory modules, and one or more processors for executing instructions based on software maintained on the one or more memory modules.

The client machine (maintains or has access to) game data 102, which when executed on the one or more processors of client machine 101, causes a video game to become playable. The game data is initially maintained in non-volatile memory, such as internal memory of machine 101, or on a carrier medium readable by machine 101 (for example a DVD or the like). When the game is executed/played, portions of the dame data are loaded into volatile memory to allow the game to execute.

As the game executes, some portions of the game data are rendered and displayed on a client display 103, thereby to provide a graphical representation of the game to a player 104. The player views the video game via display 103, and interacts via a client input device 106, such as a peripheral control pad, thereby to interact with the game. It will be appreciated that there may be multiple output devices (including audio, tactile, etc) for communicating aspects of the game to the player, and multiple input devices for receiving the player's input.

In the present embodiment, game data 102 includes environment data, being data indicative of a 3D virtual environment. This data is rendered for display on display 103 thereby to provide a graphical representation 107 of a virtual environment, including various virtual objects such as walls, characters, buildings, particles, textures, and so on.

The environment data initially takes the form of stored environment data 108 (in non-volatile memory). Based on instructions provided by other aspects of the game data, portions of the environment data are loaded into volatile memory, to become loaded environment data 109. This loaded environment data is available for rendering on screen, thereby to provide to the player a visual representation of the virtual environment. The amount of environment data loaded into environment data 109 varies between games, and often depends on factors such as memory availability, environment complexity, dynamic changes, and the like.

The game data additionally provides a client object management module 111, being a software component configured for implementing various functionalities relevant to embodiments of the present invention. In particular, the client object management module 111 is configured to communicate with a server object management module 121, being a software component that executes on a remote game server 120 (which may include a plurality of distributed machines/components). For example, the communication between client module 111 and server module 121 may be via an Internet connection.

In broad terms, communication between client module 111 and server module 121 allows a virtual object to be added to the environment data based on instructions provided by the game server. According to some embodiments, this is used to allow the game server to coordinate the implementation of a virtual object at in game data executing on a plurality of client machines, thereby to facilitate a “treasure hunt” whereby players concurrently seek the same virtual object. For the present purposes, the term “server-driven object implementation” is used to describe an arrangement whereby game server 120 coordinates the implementation of one or more virtual objects into game data 102 (for example into environment data 108 and/or environment data 109).

Server 120 communicates with a plurality of client machines, thereby to allow implementation of virtual objects in games executing on those machines. For example, a common virtual object is optionally concurrently implemented in respect of game data on each of those machines. Server 120 includes an object management interface 122 for allowing an administrator to coordinate the implementation of objects across the plurality of client terminals, and an object database 123 for maintaining data indicative of objects (including those presently being implemented).

In the present embodiments, objects implemented via server-driven object implementation are uniquely discoverable. In this sense, “uniquely discovered” means that if an object has been discovered by one player, subsequent discovery by other players is no longer unique. In some embodiments an object remains discoverable by other players, although it is no longer uniquely discoverable. In other embodiments, once an object has been uniquely discovered, it is removed from the game such that it can not subsequently be discovered by any player.

### Method Overview

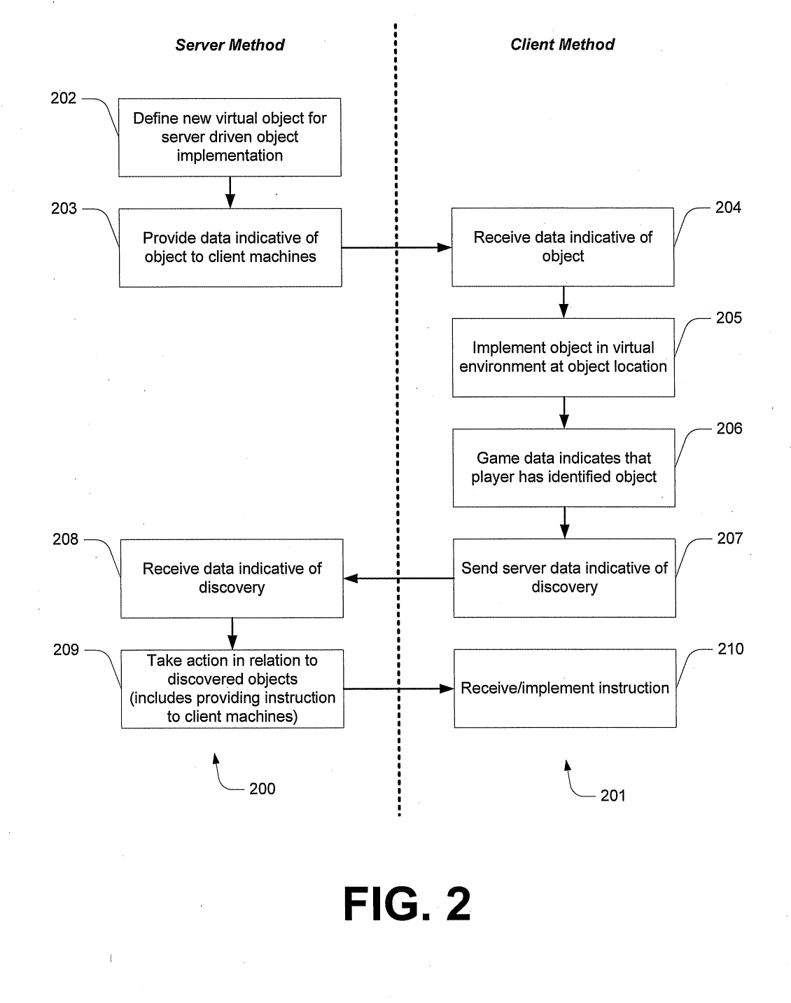

FIG. 2 illustrates a server method 200 according to an embodiment of the present invention, and a client method 201 according to an embodiment of the invention. These are implemented based on modules 121 and 111 respectively, although optionally in conjunction with other server and/or client based software components.

Step 202 includes, at the game server, defining data indicative of a virtual object for server-driven object implementation. The defined data includes an object identifier, being an aspect of data used to identify the object in the context of a plurality of objects defined by such a method. This data optionally includes other aspects, such as one or more of the following:
Data to allow the rendering of the object, including either renderable data for provision to the client machines, or a reference to renderable data already available to the client machines (for example a reference to a pre-existing renderable object in a client machine's local game data).
Data indicative of a specified object location in the virtual environment of game data 102, at which the object is to be positioned upon implementation.
Data indicative of clues for distribution to players, optionally via their respective client machines/game data.
Data indicative of implementation logistics, such as timing.
Other data.

This data is optionally defined manually in the first instance, using a software component such as management interface 122. For example, an administrator defines properties for a new object that is to be implemented via the present arrangement. Not all aspects of data are immediately populated or require manual interaction; some of these are populated subsequently and/or via automated processes (for example based on player tracking).

Step 203 includes providing to a plurality of client machines data indicative of the virtual object, and data indicative of an instruction to implement the object in a virtual environment. The extent of data provided varies between embodiments, depending on the amount of information required by the client machines to implement the instructions. For example, it is relevant whether there is a need to transfer data for allowing local rendering of the object at that point in time.

Step 204 includes receiving, at a given client machine, the data indicative of the virtual object, and data indicative of an instruction to implement the object in a virtual environment. In one example, module 111 periodically (for example upon game startup) sends a request to module 121 to request such data and/or instructions. In other examples, module 121 periodically pushes data to the client machines without requiring a request (although establishing communications between module 121 and each module 111 is an initial requirement). In some embodiments data for allowing the on-screen rendering of the virtual object is at all times maintained at the central server, and rendered based on data read from that server (i.e. the data is never stored in local memory).

Step 205 includes implementing the object in the virtual environment at an object location, such that the virtual object is able to be discovered by a player when the object location and virtual object are rendered on-screen. The manner of implementation varies between embodiments, and may include:
Writing data indicative of the object to stored environment data 108, such that the object is loaded into loaded environment data 109 at substantially the same time as the object location.
Setting a rule such that upon loading the object location into data 109, module 111 (or another component) inserts the object into data 109.
Setting a rule such that when the player navigates to a virtual position proximal the object location, the virtual object is added to data 109.
Setting a rule such that when the player navigates to a virtual position proximal the object location, module 111 contacts module 121 to obtain instructions in relation to whether or not the object should be added to data 109.

In any event, the implementation is hidden to the player, preferably using various forms of encryption, masking and data protection generally.

The object location may be specified by the game server, or by the client's game data. In this regard, although in some embodiments the object location is defined at the game server and common across all client machines (allowing for a common treasure hunt), in other cases the locations vary randomly or systematically between client machines.

Step 206 includes discovery of the virtual object by the player. In some embodiments such discovery occurs when the virtual object is visibly rendered on-screen. In other embodiments there is a requirement that the player undergo a predetermined virtual interaction with the object (for example by way of a virtual character controlled by the player). In any event, the general notion is that there is evidence of the player having discovered the object.

Upon discovery of the virtual object, the method progresses to step 207, where module 111 provides to module 121 data indicative of that discovery, presently including data indicative of the object identifier and data indicative of the player. In this regard, players are typically subjected to a registration procedure prior to gaining access to substantive functionalities of game server 120.

Step 208 includes, at the game server, receiving data indicative of the discovery. Then, at step 209, responsive to receipt of that data, the game server takes action such that the virtual object is not subsequently able to be uniquely discovered by a player. In this sense, “uniquely discovered” means that an object has been discovered once, subsequent discovery by other players is no longer unique. In some embodiments taking action such that the virtual object is not subsequently able to be discovered by a player includes providing to the plurality of client machines a further instruction in relation to the virtual object. For example, the further instruction instructs the client machines to no longer implement the virtual object, such that the virtual object is not subsequently able to be discovered by a player at all. The client machines implement such an instruction at step 210, which in the present example effectively includes reversing the implementation process of step 205.

### Practical Implementation Examples

According to the present embodiments, the present server-driven object implementation approaches are applied as a secondary gaming functionality. That is, the game data relates to a primary gaming functionality, which is able to operate in absence of server-driven object implementation. Functionalities related to server-driven object implementation, are applied for increased entertainment value or promotional purposes. For example, in one embodiment server-driven object implementation allows for an in-game treasure hunt, potentially unrelated to the game itself, as it exists in isolation (or as it was defined at the time of sale), for providing additional playability for players. In some cases players are provided with physical rewards for uniquely discovering the relevant object or objects. For example, the player might be rewarded with a physical watch for uniquely discovering a virtual watch in the game.

In some embodiments module 111 is an aftermarket add-on to an existing game (for example as downloadable content, or DLC), allowing such an existing game to function in a new manner, therefore example so as to allow distributed players to partake in a treasure hunt promotion in accordance with an embodiment of the present invention. In some such cases, module 111 is at that time installed on internal memory of client machine 101, and modifies the operation of game data maintained on a carrier medium such as a CD or DVD, for example as an aftermarket downloadable patch. This allows for promotion of older game titles.

In some embodiments, in the case that a client machine implements the virtual object, the client machine delivers to the player one or more clues in relation to the virtual object and/or object location. For example, the clues are implemented during game play, and these clues are optionally downloaded to the client machines in conjunction with data indicative of the object. In other embodiments, clues are made available through other mechanisms, such as via messages printed on consumer goods, via other media (such as pint, television, or radio), and so on. For example, in one embodiment clues are printed on the inside of soft drink bottle caps, allowing for cross-promotion of the soft drink and game.

In some embodiments, rather than storing data at the client side as add-ons, data is stored at the server side and activated as required, thereby to reduce network bandwidth requirements.

In some embodiments the game server tracks activities of players (for example the location of a player controlled character in the virtual environment). This is optionally used to notify garners within a threshold distance of an object in relation to various events, including the discovery of the relevant object by the player or another player. This reduces the need to broadcast messages to a large number of players.

In some embodiments leader boards are used to rank the achievements of players in terms of discovering virtual objects.

In some embodiments a separate game server is provided for each form of console, whereas in other embodiments multiple forms of console share a common game server.

In some embodiments the present functionalities are implemented for a team-based mode, whereby multiple players compete cooperatively alongside one another with a view to discovering virtual objects.

### CONCLUSIONS AND INTERPRETATION

It will be appreciated that the above disclosure provides various advantageous systems and methods for managing virtual objectives in a video game. In particular, server-driven object implementation allows for various useful functionalities, including promotional treasure hunts and other value-add components for new and existing video games.

As noted, although the above disclosure focuses primarily on objectives that require the discovery of a virtual object, other embodiments deal with virtual objectives in a broader sense. The crux is that a game operates based on a certain set of predefined objectives when in an offline mode, but when played in a online mode is supplemented with one or more additional objectives supported by a central game server. These additional objectives are able to be centrally modified over time at the game server.

Unless specifically stated otherwise, as apparent from the following discussions, it is appreciated that throughout the specification discussions utilizing terms such as “processing,” “computing,” “calculating,” “determining”, analyzing” or the like, refer to the action and/or processes of a computer or computing system, or similar electronic computing device, that manipulate and/or transform data represented as physical, such as electronic, quantities into other data similarly represented as physical quantities.

In a similar manner, the term “processor” may refer to any device or portion of a device that processes electronic data, e.g., from registers and/or memory to transform that electronic data into other electronic data that, e.g., may be stored in registers and/or memory. A “computer” or a “computing machine” or a “computing platform” may include one or more processors.

The methodologies described herein are, in one embodiment, performable by one or more processors that accept computer-readable (also called machine-readable) code containing a set of instructions that when executed by one or more of the processors carry out at least one of the methods described herein. Any processor capable of executing a set of instructions (sequential or otherwise) that specify actions to be taken are included. Thus, one example is a typical processing system that includes one or more processors. Each processor may include one or more of a CPU, a graphics processing unit, and a programmable DSP unit. The processing system further may include a memory subsystem including main RAM and/or a static RAM, and/or ROM. A bus subsystem may be included for communicating between the components. The processing system further may be a distributed processing system with processors coupled by a network. If the processing system requires a display, such a display may be included, e.g., a liquid crystal display (LCD) or a cathode ray tube (CRT) display. If manual data entry is required, the processing system also includes an input device such as one or more of an alphanumeric input unit such as a keyboard, a pointing control device such as a mouse, and so forth. The term memory unit as used herein, if clear from the context and unless explicitly stated otherwise, also encompasses a storage system such as a disk drive unit. The processing system in some configurations may include a sound output device, and a network interface device. The memory subsystem thus includes a computer-readable carrier medium that carries computer-readable code (e.g., software) including a set of instructions to cause performing, when executed by one or more processors, one of more of the methods described herein. Note that when the method includes several elements, e.g., several steps, no ordering of such elements is implied, unless specifically stated. The software may reside in the hard disk, or may also reside, completely or at least partially, within the RAM and/or within the processor during execution thereof by the computer system. Thus, the memory and the processor also constitute computer-readable carrier medium carrying computer-readable code.

Furthermore, a computer-readable carrier medium may form, or be included in a computer program product.

In alternative embodiments, the one or more processors operate as a standalone device or may be connected, e.g., networked to other processor(s), in a networked deployment, the one or more processors may operate in the capacity of a server or a user machine in server-user network environment, or as a peer machine in a peer-to-peer or distributed network environment. The one or more processors may form a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine.

Note that while some diagrams only show a single processor and a single memory that carries the computer-readable code, those in the art will understand that many of the components described above are included, but not explicitly shown or described in order not to obscure the inventive aspect. For example, while only a single machine is illustrated, the term “machine” shall also be taken to include any collection of machines that individually or jointly execute a set (or multiple sets) of instructions to perform any one or more of the methodologies discussed herein.

Thus, one embodiment of each of the methods described herein is in the form of a computer-readable carrier medium carrying a set of instructions, e.g., a computer program that is for execution on one or more processors, e.g., one or more processors that are part of web server arrangement. Thus, as will be appreciated by those skilled in the art, embodiments of the present invention may be embodied as a method, an apparatus such as a special purpose apparatus, an apparatus such as a data processing system, or a computer-readable carrier medium, e.g., a computer program product. The computer-readable carrier medium carries computer readable code including a set of instructions that when executed on one or more processors cause the processor or processors to implement a method. Accordingly, aspects of the present invention may take the form of a method, an entirely hardware embodiment, an entirely software embodiment or an embodiment combining software and hardware aspects. Furthermore, the present invention may take the form of carrier medium (e.g., a computer program product on a computer-readable storage medium) carrying computer-readable program code embodied in the medium.

The software may further be transmitted or received over a network via a network interface device. While the carrier medium is shown in an exemplary embodiment to be a single medium, the term “carrier medium” should be taken to include a single medium or multiple media (e.g., a centralized or distributed database, and/or associated caches and servers) that store the one or more sets of instructions. The term “carrier medium” shall also be taken to include any medium that is capable of storing, encoding or carrying a set of instructions for execution by one or more of the processors and that cause the one or more processors to perform any one or more of the methodologies of the present invention. A carrier medium may take many forms, including but not limited to, non-volatile media, volatile media, and transmission media. Non-volatile media includes, for example, optical, magnetic disks, and magneto-optical disks. Volatile media includes dynamic memory, such as main memory. Transmission media includes coaxial cables, copper wire and fiber optics, including the wires that comprise a bus subsystem. Transmission media also may also take the form of acoustic or light waves, such as those generated during radio wave and infrared data communications. For example, the term “carrier medium” shall accordingly be taken to included, but not be limited to, solid-state memories, a computer product embodied in optical and magnetic media; a medium bearing a propagated signal detectable by at least one processor of one or more processors and representing a set of instructions that, when executed, implement a method; a carrier wave bearing a propagated signal detectable by at least one processor of the one or more processors and representing the set of instructions a propagated signal and representing the set of instructions; and a transmission medium in a network bearing a propagated signal detectable by at least one processor of the one or more processors and representing the set of instructions.

It will be understood that the steps of methods discussed are performed in one embodiment by an appropriate processor (or processors) of a processing (i.e., computer) system executing instructions (computer-readable code) stored in storage. It will also be understood that the invention is not limited to any particular implementation or programming technique and that the invention may be implemented using any appropriate techniques for implementing the functionality described herein. The invention is not limited to any particular programming language or operating system.

Reference throughout this specification to “one embodiment” or “an embodiment” means that a particular feature, structure or characteristic described in connection with the embodiment is included in at least one embodiment of the present invention. Thus, appearances of the phrases “in one embodiment” or “in an embodiment” in various places throughout this specification are not necessarily all referring to the same embodiment, but may. Furthermore, the particular features, structures or characteristics may be combined in any suitable manner, as would be apparent to one of ordinary skill in the art from this disclosure, in one or more embodiments.

Similarly it should be appreciated that in the above description of exemplary embodiments of the invention, various features of the invention are sometimes grouped together in a single embodiment, FIG., or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the Detailed Description are hereby expressly incorporated into this Detailed Description, with each claim standing on its own as a separate embodiment of this invention.

Furthermore, while some embodiments described herein include some but not other features included in other embodiments, combinations of features of different embodiments are meant to be within the scope of the invention, and form different embodiments, as would be understood by those skilled in the art. For example, in the following claims, any of the claimed embodiments can be used in any combination.

Furthermore, some of the embodiments are described herein as a method or combination of elements of a method that can be implemented by a processor of a computer system or by other means of carrying out the function. Thus, a processor with the necessary instructions for carrying out such a method or element of a method forms a means for carrying out the method or element of a method. Furthermore, an element described herein of an apparatus embodiment is an example of a means for carrying out the function performed by the element for the purpose of carrying out the invention.

In the description provided herein, numerous specific details are set forth. However, it is understood that embodiments of the invention may be practiced without these specific details. In other instances, well-known methods, structures and techniques have not been shown in detail in order not to obscure an understanding of this description.

Similarly, it is to be noticed that the term coupled, when used in the claims, should not be interpreted as being limited to direct connections only. The terms “coupled” and “connected,” along with their derivatives, may be used. It should be understood that these terms are not intended as synonyms for each other. Thus, the scope of the expression a device A coupled to a device B should not be limited to devices or systems wherein an output of device A is directly connected to an input of device B. It means that there exists a path between an output of A and an input of B which may be a path including other devices or means. “Coupled” may mean that two or more elements are either in direct physical or electrical contact, or that two or more elements are not in direct contact with each other but yet still co-operate or interact with each other.

Thus, while there has been described what are believed to be the preferred embodiments of the invention, those skilled in the art will recognize that other and further modifications may be made thereto without departing from the spirit of the invention, and it is intended to claim all such changes and modifications as falling within the scope of the invention. For example, any formulas given above are merely representative of procedures that may be used. Functionality may be added or deleted from the block diagrams and operations may be interchanged among functional blocks. Steps may be added or deleted to methods described within the scope of the present invention.

1. A method for modifying the operation of a video game executed at a client machine, the method including:
at a game server, defining data indicative of a virtual objective, the data including an objective identifier;
at the game server, providing to a plurality of client machines data indicative of the virtual objective, and data indicative of an instruction to implement the objective in a virtual environment;
at a client machine, receiving the data indicative of the virtual object, and data indicative of an instruction to implement the object in a virtual environment;
at the client machine, implementing the objective in the context of the virtual environment, such that the virtual objective is able to be completed by a player;
at the client machine, upon completion of the virtual objective by the player, providing to the game server data indicative of that completion, including data indicative of the objective identifier and data indicative of the player; and
at the game server, responsive to receipt of the data indicative of the completion, taking action such that the virtual objective is not subsequently able to be uniquely completed by a player.

2. A method according to claim 1 wherein the virtual objective includes a task to locate a virtual object, and the method includes:
at the game server, defining data indicative of a virtual object, the data including an object identifier;
at the game server, providing to a plurality of client machines data indicative of the virtual object, and data indicative of an instruction to implement the object in a virtual environment;
at a client machine, receiving the data indicative of the virtual object, and data indicative of an instruction to implement the object in a virtual environment;
at the client machine, implementing the object in the virtual environment at an object location, such that the virtual object is able to be discovered by a player when the object location and virtual object are rendered on-screen;
at the client machine, upon discovery of the virtual object by the player, providing to the game server data indicative of that discovery, including data indicative of the object identifier and data indicative of the player; and
at the game server, responsive to receipt of the data indicative of the discovery, taking action such that the virtual object is not subsequently able to be uniquely discovered by a player.

3. A method according to claim 1 wherein taking action such that the virtual objective is not subsequently able to be uniquely discovered by a player includes providing to the plurality of client machines a further instruction in relation to the virtual objective.

4. A method according to claim 1 wherein taking action such that the virtual object is not subsequently able to be uniquely discovered by a player includes providing to the plurality of client machines a further instruction in relation to the virtual object, and wherein the further instruction instructs the client machines to no longer implement the virtual object, such that the virtual object is not subsequently able to be discovered by a player.

5. A method according to claim 1 wherein taking action such that the virtual objective is not subsequently able to be completed by a player includes ceasing to provide to the plurality of client machines data indicative of the virtual object.

6. A method according to claim 1 wherein, in the case that a client machine implements the virtual objective, the client machine delivers to the player one or more clues in relation to the virtual objective and/or object location of a virtual object referenced by the virtual objective.

7. A method according to claim 2 wherein the object location is defined by the game server.

8. A method according to claim 2 wherein the object location is common across each of the client machines.

9. A method according to claim 2 wherein data for allowing the on-screen rendering of the virtual object is at all times maintained at the game server.

10. A method according to claim 2 wherein data indicative of the object and/or object location is encrypted.

11. A method according to claim 1 wherein the player receives a prize for completed the objective, wherein a determination to award the prize is made at the game server.

12. A method, at a game server, for modifying the operation of a video game executed at a client machine, the method including:
defining data indicative of a virtual objective, the data including an objective identifier;
providing to a plurality of client machines data indicative of the virtual objective, and data indicative of an instruction to implement the objective in a virtual environment, wherein the client machines each implement the objective in the virtual environment, such that the virtual objective is able to be completed by a player and, upon completion of the virtual objective by the player, provide to the game server data indicative of that completion, including data indicative of the objective identifier and data indicative of the player; and
responsive to receipt of the data indicative of the completion, taking action such that the virtual objective is not subsequently able to be uniquely completed by a player.

13. A method according to claim 12, wherein the virtual objective includes a task to locate a virtual object, and the method includes:
defining data indicative of a virtual object, the data including an object identifier;
providing to the plurality of client machines data indicative of the virtual object, and data indicative of an instruction to implement the object in a virtual environment, wherein the client machines each implement the object in the virtual environment at an object location, such that the virtual object is able to be discovered by a player when the object location and virtual object are rendered on-screen and, upon discovery of the virtual object by the player, provide to the game server data indicative of that discovery, including data indicative of the object identifier and data indicative of the player; and
responsive to receipt of the data indicative of the discovery, taking action such that the virtual object is not subsequently able to be uniquely discovered by a player.

14. A method according to claim 13 wherein taking action such that the virtual object is not subsequently able to be uniquely discovered by a player includes providing to the plurality of client machines a further instruction in relation to the virtual object.

15. A method according to claim 13 wherein data for allowing the on-screen rendering of the virtual object is at all times maintained at the game server.

16. A method, at a client machine, for managing virtual objectives in a video game, the method including:
receiving from a game server data indicative of a virtual objective, the data including an objective identifier, and data indicative of an instruction to implement the objective in a virtual environment, wherein the data indicative of the virtual objective, and data indicative of an instruction to implement the objective in a virtual environment, are provided by the game server to a plurality of client machines;
implementing the objective in the context of the virtual environment, such that the virtual objective is able to be completed by a player;
completion of the virtual objective by the player, providing to the game server data indicative of that completion, including data indicative of the objective identifier and data indicative of the player, such that, responsive to receipt of the data indicative of the completion, the game server responds by taking action such that the virtual objective is not subsequently able to be uniquely completed by a player.

17. A method according to claim 16, wherein the virtual objective includes a task to locate a virtual object, and the method includes:
receiving from the game server data indicative of a virtual object, the data including an object identifier, and data indicative of an instruction to implement the object in a virtual environment, wherein the data indicative of the virtual object, and data indicative of an instruction to implement the object in a virtual environment, are provided by the game server to a plurality of client machines;
implementing the object in the virtual environment at an object location, such that the virtual object is able to be discovered by a player when the object location and virtual object are rendered on-screen;
discovery of the virtual object by the player, providing to the game server data indicative of that discovery, including data indicative of the object identifier and data indicative of the player, such that, responsive to receipt of the data indicative of the discovery, the game server responds by taking action such that the virtual object is not subsequently able to be uniquely discovered by a player.

18. A method according to claim 16 wherein taking action such that the virtual objective is not subsequently able to be uniquely discovered by a player includes providing to the plurality of client machines a further instruction in relation to the virtual object.

19. A method according to claim 17 wherein the object location is defined by the game server, and the object location is common across each of the client machines.

20. A method according to claim 17 wherein data for allowing the on-screen rendering of the virtual object is at all times maintained at the central server.
